(19) United States
(12) Patent Application Publication
(10) Pub. No.: US 2022/0347611 A1
(43) Pub. Date: Nov. 3, 2022

(54) HIGH PARTICLE CAPTURE MOISTURE ABSORBING FABRIC

(71) Applicant: Brian D. Babcock, Columbia, TN (US)

(72) Inventor: Brian D. Babcock, Columbia, TN (US)

(21) Appl. No.: 17/246,664

(22) Filed: May 2, 2021

(51) Int. Cl. B01D 39/18; B01D 39/16; D04H 1/04; D04H 3/011; D04H 3/015

(52) U.S. Cl. CPC B01D 39/18; B01D 39/1623; D04H 1/04; D04H 3/011; D04H 3/015; B01D 2239/0428; B01D 2239/0421; B01D 2239/1233; B01D 2239/1258; B01D 2239/0636; B01D 2239/0613; B01D 2239/0216; B01D 2239/025; D10B 2505/04; D10B 2331/04; D10B 2201/20; D10B 2401/021; D10B 2401/022

(57) ABSTRACT

A gas filtering medium is composed of hydrophobic polyester fiber as from 20-80% by total weight of textile fibers and 80-20% by total weight of hydrophilic textile fibers and a microfibrillated cellulose fiber in a weight/weight ratio of 1.5-8.5/100 parts by weight of total textile fiber.

### BACKGROUND OF THE INVENTION

### 1. Field of the Invention

The present invention relates to fabric blends, especially non-woven fabric blends, and non-woven fabric blends with an increased particle-capture rate when fluid flows through the fabric.

### 2. Background of the Art

In recent years, the prevalence of nosocomial infections has had serious implications for both patients and healthcare workers and the severity of airborne diseases brought into medical care facilities (including clinics, hospitals and long-term care homes) has reached a level of concern for health care workers. Such significant airborne diseases include at least COVID-19, SARS, H1N1 virus, and mutations in seasonal viruses. Nosocomial infections are those that originate, persist or occur in a hospital, long-term care facility, or other health care setting, and are sometimes referred to as “hospital associated infections” or HAI. In general, nosocomial infections are more serious and dangerous than external, community-acquired infections because the pathogens in hospitals are more virulent and tend to be more resistant to typical antibiotics. These HAIs are usually related to a procedure or treatment used to diagnose or treat the patient's illness or injury and may be spread by indirect, inadvertent contact. Published U.S. Patent Application Document 2007/0044801 and Published U.S. Patent Application Document 2007/0141126 and U.S. Pat. No. 4,856,509 disclose face masks containing antimicrobial ingredients that are used as a first barrier against inhalation of such diseases, usually viruses. Bacterial infections are also becoming significant issues, with Methicyllin Resistant Strep A (MRSA) becoming a major health issue, although this is usually spread by contact rather than inhalation.

Infection control has been a formal discipline in the United States since the 1950s, due to the spread of staphylococcal infections in hospitals. Because there is both the risk of health care providers acquiring infections themselves, and of them passing infections on to patients, the Centers for Disease Control and Prevention have established guidelines for infection control procedures. In addition to hospitals, infection control is important in nursing homes, clinics, physician offices, child care centers, and restaurants, as well as in the home. The purpose of infection control in hospital and clinical environments is to reduce the occurrence of infectious diseases. These diseases are usually caused by bacteria or viruses and can be spread by human to human contact, animal to human contact, human contact with an infected surface, airborne transmission, and, finally, by such common vehicles as food or water. The use of medical devices such as gloves, gowns, and masks as barriers to pathogens is already well appreciated by infection control practitioners. It is apparent by the increase in antibiotic resistance and the persistence of HAIs, however, that these practices alone are not enough.

Hospitals and other healthcare facilities have developed extensive infection control programs to prevent nosocomial infections. Even though hospital infection control programs and a more conscientious effort on the part of healthcare workers to take proper precautions when caring for patients can prevent some of these infections, a significant number of infections still occur. Therefore, the current procedures are not sufficient. Despite enforcement of precautionary measures (e.g. washing hands, wearing gloves, face mask and cover gowns), contact transfer is still a fundamental cause of HAIs. That is, individuals who contact pathogen-contaminated surface such as table tops, bed rails, hands, clothing and/or medical instruments, can still transfer the pathogens from one surface to another immediately or within a short time after initial contact. To improve this situation, a standard device or article can be enhanced for infection control by addition of actives that can kill pathogens when they come in contact with the article or can bind the pathogen such that dispersal is not possible. One problem with masks is that they tend to concentrate microbes on the surface of the mask, and even where antimicrobial activity is provided with the mask, that activity tends to be internal and slow acting, and diminishes over time, allowing microbial buildup on the mask surface. Therefore when the mask is contacted, even for removal, the user can pick up concentrated microbes on their hands and spread them to others, other surfaces and to themselves.

In the COVID-19 pandemic beginning in 2020, one of the most effective methods of reducing the rate of spread of the virus is the universal use of effective filtering masks by the population whenever persons are within 20 feet of each other. The use of masks by all persons in contact over a twenty-minute period can reduce microbial transfer between wearers by more than 80% with both persons wearing effective filtering masks. To be effective, the masks must filter moisture droplets out of the air, retain the droplets, not redisperse the droplets, and preferably attack any microbes brought into the mask by the filtration of air by the breathing pattern of the user.

U.S. Pat. No. 10,182,946 (Gray) is an example of a high quality mask material that can meet these goals. A filter material entraps particles and actively affects the trapped particles within the filter. The fabric has a blend of hydrophilic superabsorbent fibers and non-superabsorbent hydrophilic fibers that is sufficiently porous as to allow gaseous flow through the fabric. The fabric having a thickness and the fabric has as a coating of a mixture of a chemically or physically active compound and a liquid carrier forming an active composition on both the outer surface of the hydrophilic superabsorbent fibers, and the hydrophilic superabsorbent fibers have a central volume also retaining the active composition. The central volume of the hydrophilic superabsorbent fibers acting as a reservoir for replacement of the active compound into the coating when concentration of active compounds in the coating are reduced to a concentration less than concentrations of the active compound within the central volume; and the liquid carrier is an aqueous liquid.

Further advances in fabric materials for these types of masks, gowns, room filters, machine filters and the like are still desirable.

### SUMMARY OF THE INVENTION

A gas filtering medium is provided with hydrophobic polyester fiber as from 20-80% by total weight of textile fibers and 80-20% by total weight of hydrophilic textile fibers and a microfibrillated cellulose fiber (MCF or MFC) in a weight/weight ratio of 1.5-8.5/100 parts by weight of total textile fiber. The addition of the MCF increases particle filtration properties while maintain good fabric properties.

### BRIEF DESCRIPTION OF THE FIGURES

FIG. 1 shows a chart of water retention properties for all samples, both invention and comparative.

FIG. 2 shows a chart for water retention properties for six (6) different non-woven blends of fibers.

FIG. 3 shows a chart of water retention properties for non-woven blends of fibers with and without microfibrillated cellulose.

FIG. 4 shows a chart of water retention properties for non-woven blends of fibers with Blend A.

FIG. 5 shows a chart of water retention properties for non-woven blends of fibers with Blend B.

FIG. 6 shows a chart of water retention properties for non-woven blends of fibers with Blend C.

FIG. 7 shows a graph of water retention properties for all samples, both invention and comparative.

FIG. 8 shows a graph of water retention properties for all samples of non-woven fabric.

FIG. 9 shows a graph of water retention properties for six (6) different non-woven blends of fibers.

FIG. 10 shows a graph of water retention properties for non-woven blends of fibers with and without microfibrillated cellulose.

FIG. 11 shows a graph of water retention properties for non-woven blends of fibers with Blend A.

FIG. 12 shows a graph of water retention properties for non-woven blends of fibers with Blend B.

FIG. 12 shows a graph of water retention properties for non-woven blends of fibers with Blend C.

FIG. 13 shows a graph of fractional efficiency (filtration) properties for all samples of non-woven fabric.

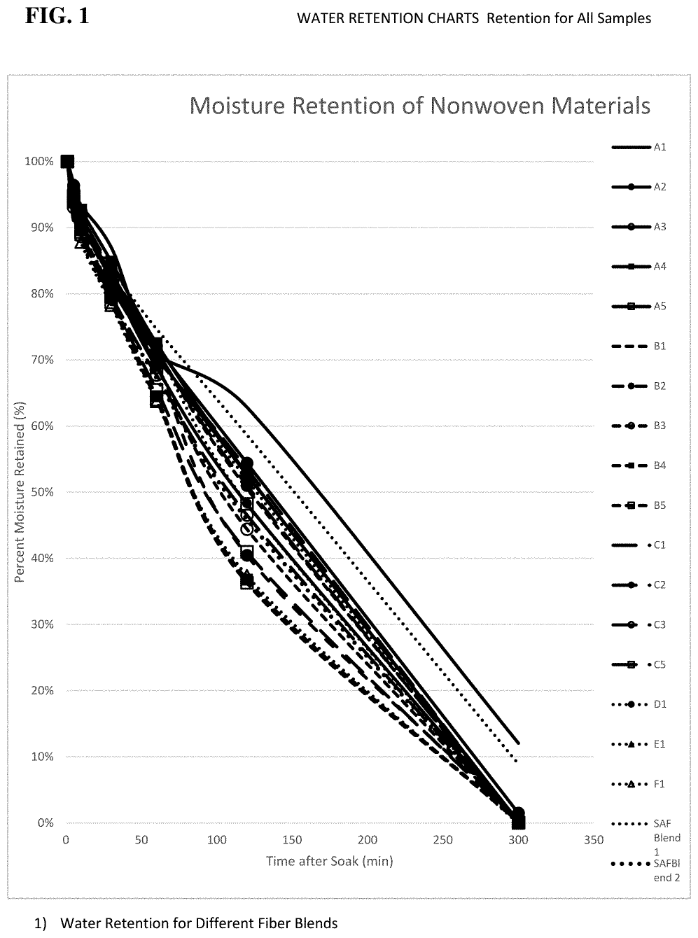

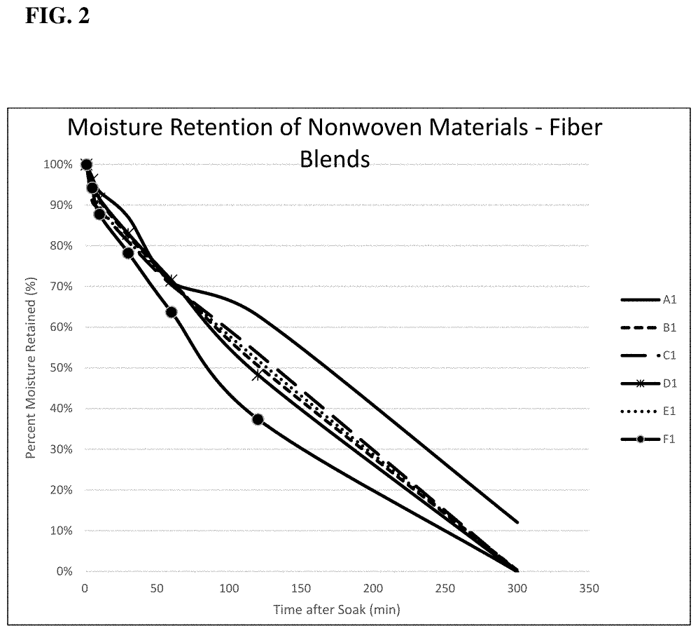

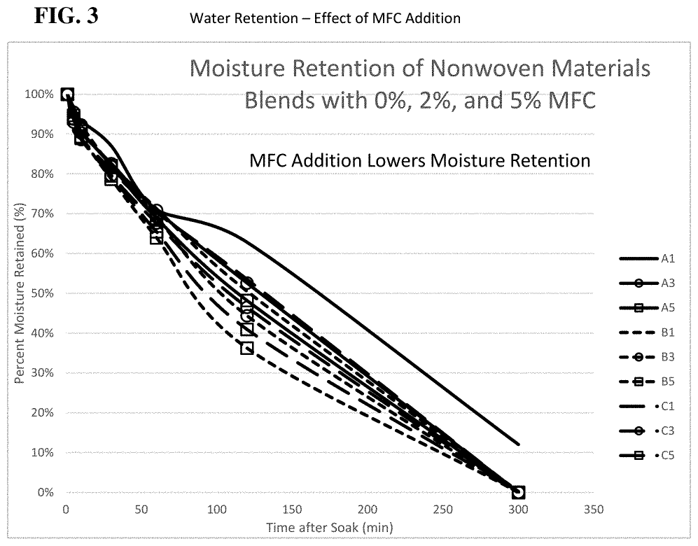

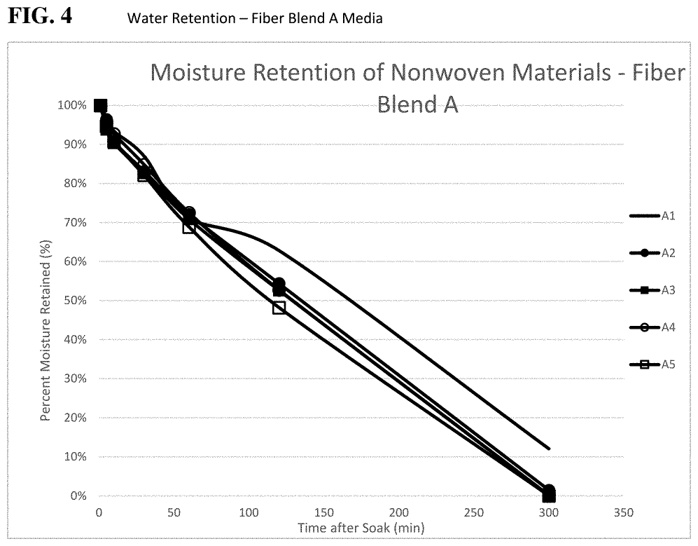

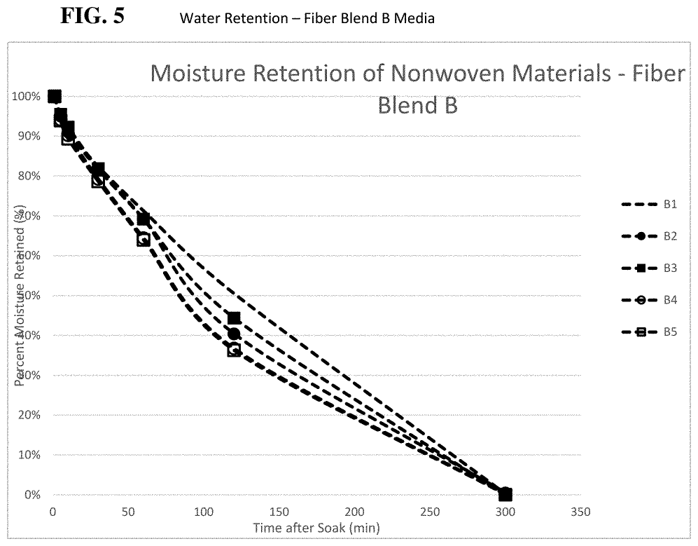

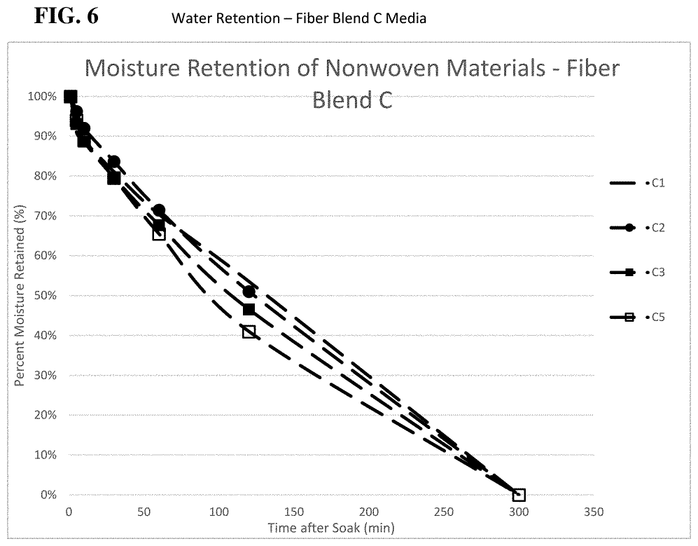

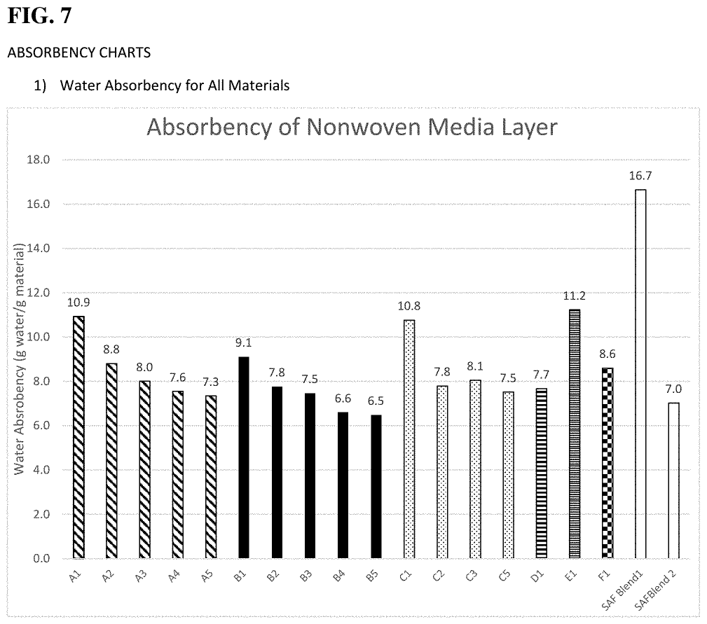

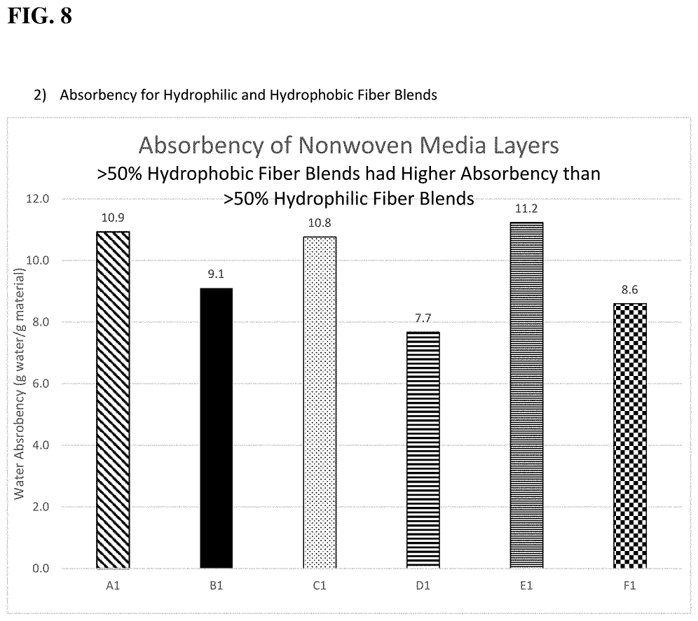

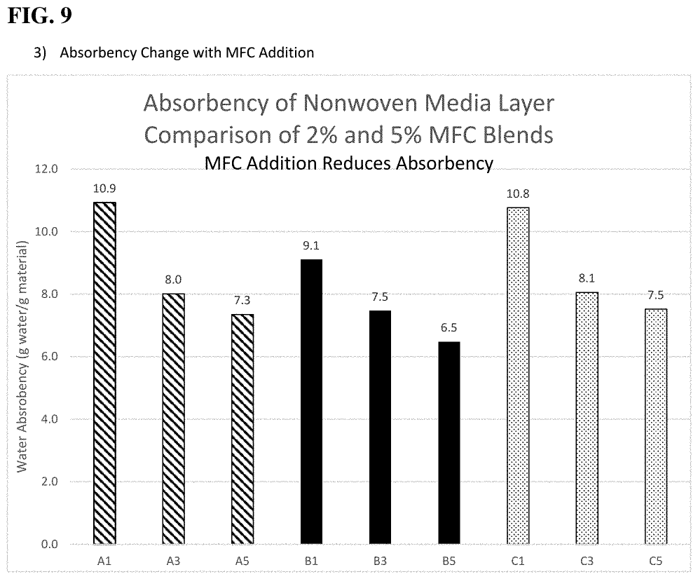

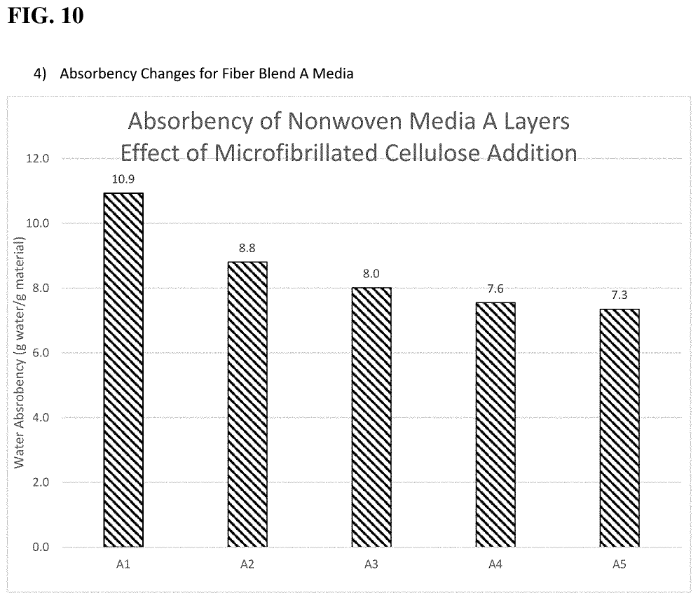

FIG. 9 shows a graph of fractional efficiency (filtration) properties for six (6) different non-woven blends of fibers.

FIG. 10 shows a graph of water retention properties for two non-woven blends of fibers with microfibrillated cellulose.

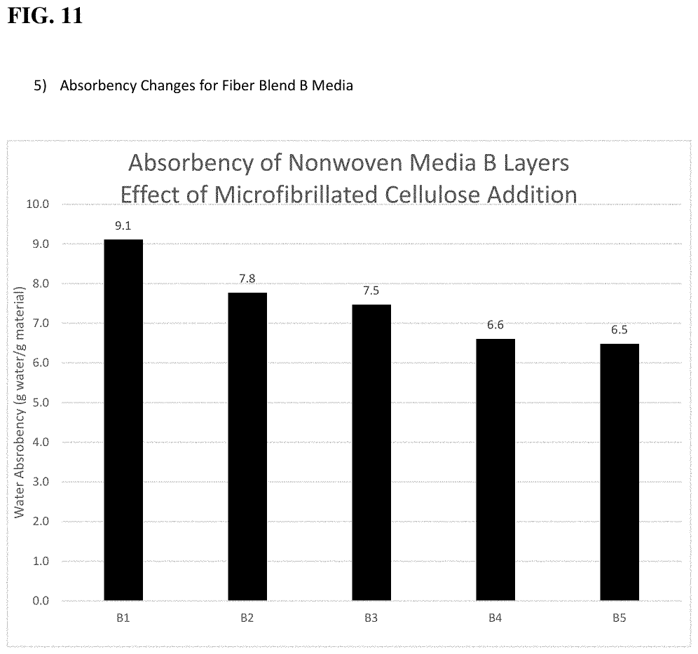

FIG. 11 shows a graph of fractional efficiency (filtration) properties for non-woven blends of fibers with Blend A.

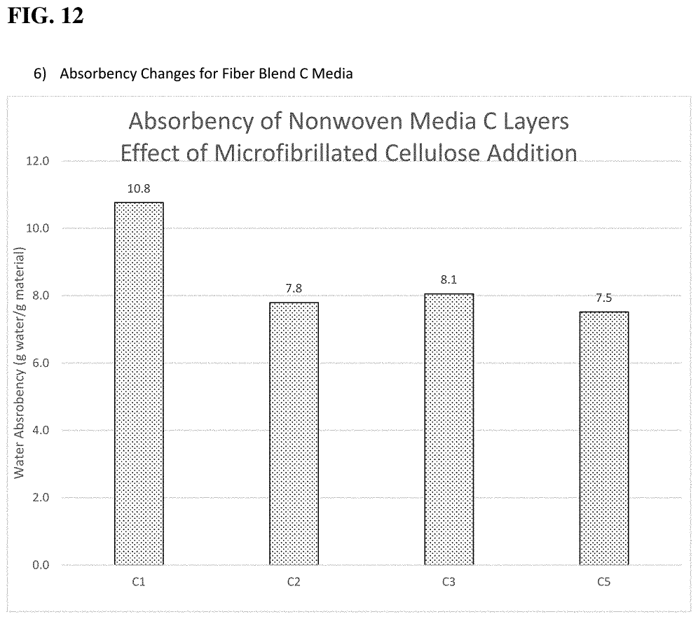

FIG. 12 shows a graph of fractional efficiency (filtration) properties for non-woven blends of fibers with Blend B.

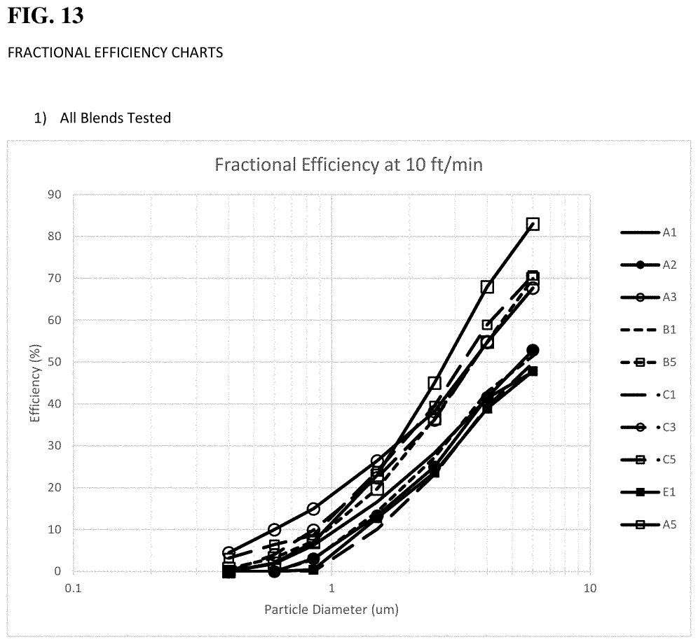

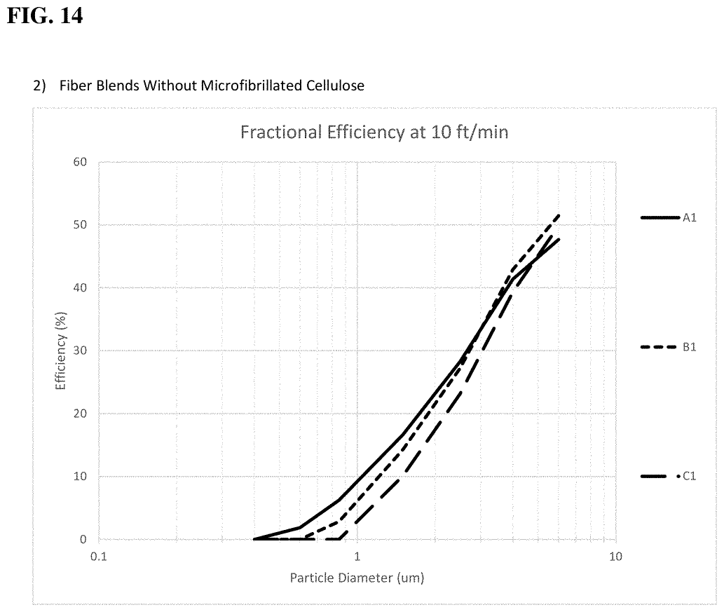

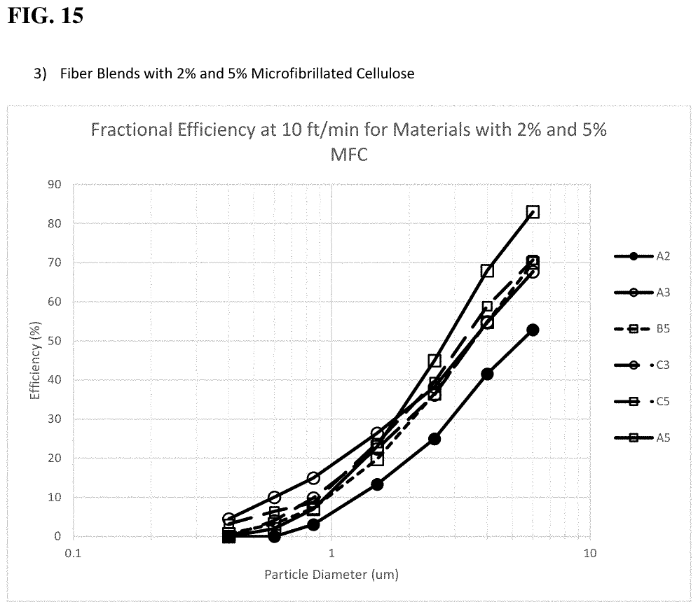

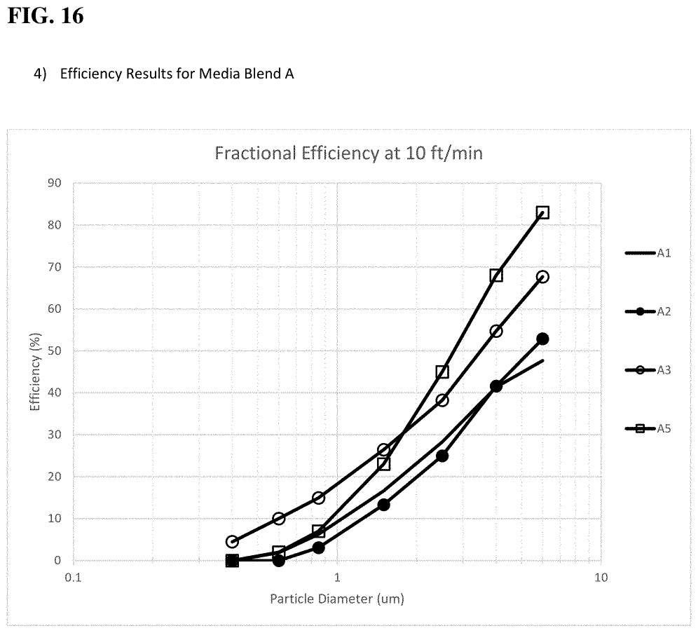

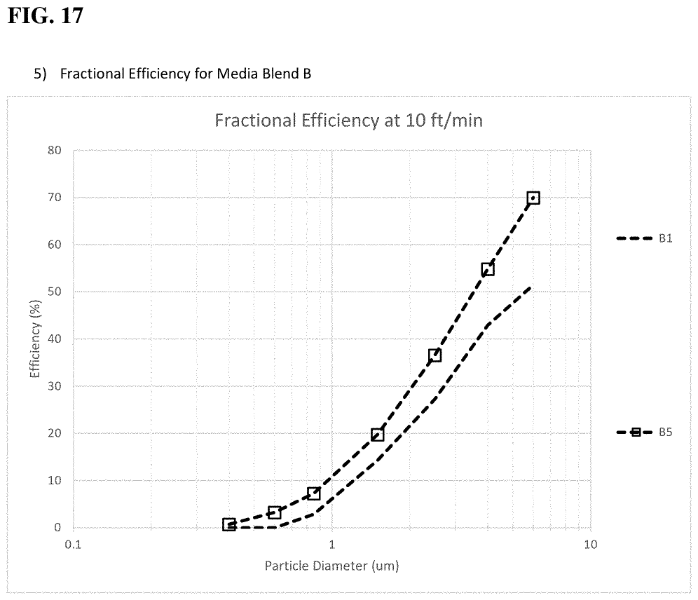

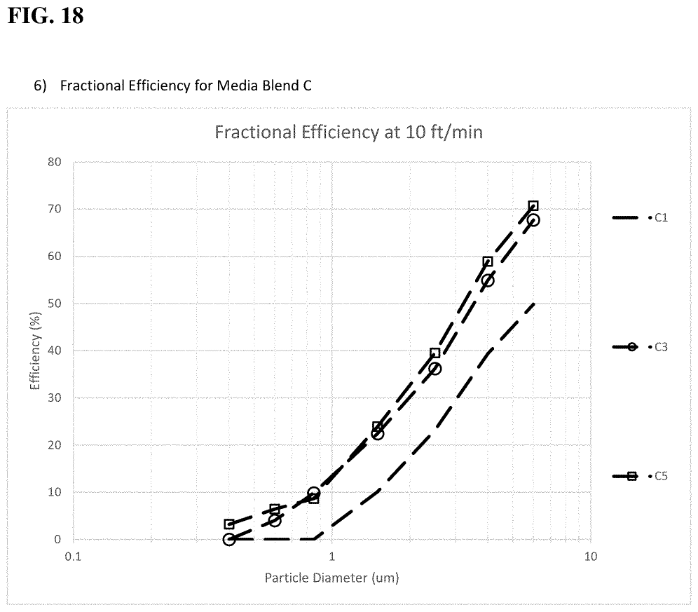

FIG. 13 shows a graph of fractional efficiency (filtration) properties for ten (10) non-woven blends of fibers with Blend C.

FIG. 14 shows a chart of Fractional Efficiency of Fiber Blends without Microfibrillated Cellulose.

FIG. 15 shows a chart of Fractional Efficiency of Fiber Blends with 2% and 5% Microfibrillated Cellulose.

FIG. 16 shows a chart of Fractional Efficiency of Media Blend A.

FIG. 17 shows a chart of Fractional Efficiency of Media Blend B.

FIG. 18 shows a chart of Fractional Efficiency of Media Blend C.

### DETAILED DESCRIPTION OF THE INVENTION

A gas filtering medium includes a hydrophobic polyester fiber as from 20-80% by total weight of textile fibers and 80-20% by total weight of hydrophilic textile fibers and a microfibrillated cellulose fiber in a weight/weight ratio of 1.5-8.5/100 parts by weight of total textile fiber. The gas filtering medium may be a non-woven fabric, and especially a wet-lain non-woven fabric.

In the gas filtering medium, hydrophilic fiber may be either a synthetic and/or a natural fiber. Natural fibers include, without limitation, cotton, wool, hair, non-microfibrillated cellulose and the like. Synthetic hydrophilic fibers include, without limitation, polyamides, polyacrylates, cellulose acetate (and other chemically modified celluloses which make them textile fabrics), vinyl resin blends (but without sufficient soluble materials such as non-crosslinked polyvinyl alcohol so as to make the fiber soluble or dispersible when soaked in water at 50 C for ten minutes), modified polyolefins, and the like.

As explained later in greater detail, the gas filtering medium should have the microfibrillated cellulose include a cellulose particle, fiber or fibril with at least one dimension less than 500 nm.

As used herein, the term “nanofibrillar cellulose” or nanofibrillar cellulose or NFC is understood to encompass nanofibrillar structures released from cellulose pulp. The nomenclature relating to nanofibrillar celluloses is not uniform and there is an inconsistent use of terms in the literature. For example, the following terms have been used as synonyms for nanofibrillar cellulose (NFC): cellulose nanofiber, nanofibril cellulose (CNF), nano-scale fibrillated cellulose, microfibrillar cellulose, cellulose microfibrils, microfibrillated cellulose (MFC), and fibril cellulose. The smallest cellulosic entities of cellulose pulp of plant origin, such as wood, include cellulose molecules, elementary fibrils, and microfibrils. Microfibril units are bundles of elementary fibrils caused by physically conditioned coalescence as a mechanism of reducing the free energy of the surfaces. Their diameters vary depending on the source. The term “nanofibrillar cellulose” or NFC refers to a collection of cellulose nanofibrils liberated from cellulose pulp, particularly from the microfibril units. Nanofibrils have typically high aspect ratio: the length exceeds one micrometer while the diameter is typically below 100 nm. The smallest nanofibrils are similar to the so-called elementary fibrils. The dimensions of the liberated nanofibrils or nanofibril bundles are dependent on raw material, any pretreatments and disintegration method. Intact, unfibrillated microfibril units may be present in the nanofibrillar cellulose but only in small or even insignificant amounts.

Microfibrillated cellulose (MFC) shall in the context of the patent application mean a nano-micro scale cellulose particle fiber or fibril with at least one dimension less than 500 nm, or less than 250 nm or less than 100 nm. Other dimensions may be up 1500 nm or more. MFC comprises partly or totally fibrillated cellulose or lignocellulose fibers. The liberated fibrils have a diameter less than the 50 nm, 250 nm or 100 nm, whereas the actual fibril diameter or particle size distribution and/or aspect ratio (length/width) depends on the source and the manufacturing methods.

Fiber and textile technology have a number of features and parameters that tend to be unique to those fields.

### Properties Denier

Denier is a property that varies depending on the fiber type. It is defined as the weight in grams of 9,000 meters of fiber. The current standard of denier is 0.05 grams per 450 meters. Yarn is usually made up of numerous filaments. The denier of the yarn divided by its number of filaments is the denier per filament (dpf). Thus, denier per filament is a method of expressing the diameter of a fiber. Obviously, the smaller the denier per filament, the more filaments there are in the yarn. If a fairly closed, tight web is desired, then lower dpf fibers (1.5 or 3.0) are preferred. On the other hand, if high porosity is desired in the web, a larger dpf fiber—perhaps 6.0 or 12.0—should be chosen. Here are the formulas for converting denier into microns, mils, or decitex: Diameter in microns=11.89×(denier/density in grams per milliliter)½ Diameter in mils=diameter in microns×0.03937 Decitex=denier×1.1

Length—The length of the preferred fiber is directly related to the diameter. This is referred to as the aspect ratio. Aspect ratio is found by dividing the length of the fiber by the diameter (using the same unit of measure for each). The ideal aspect ratio is 500:1. An example follows: Length=250 mils Diameter=0.491 mils L/D=250/0.491=509 When the correct aspect ratio is used, you receive an optimum amount of strength, as well as good dispersion. As the aspect ratio increases, the fiber becomes more difficult to disperse; as it decreases, there is a loss of strength resulting from poor binding capability. End Condition Diameter and length are both very important factors, but if there is a poor end condition on cut fiber, all has been in vain. Some product are referred to as precision-cut fiber—fiber in which all ends are squarely cut and not fused together.

The smallest fibril is called elementary fibril and has a diameter of approximately 2-4 nm (see e.g. Chinga-Carrasco, G., Cellulose fibers, nanofibrils and microfibrils, The morphological sequence of MFC components from a plant physiology and fibre technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g., by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e., protruding fibrils from the tracheid (cellulose fiber), and with a certain amount of fibrils liberated from the tracheid (cellulose fiber).

There are different acronyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. MFC can also be characterized by various physical or physical-chemical properties such as large surface area or its ability to form a gel-like material at low solids (1-5 wt %) when dispersed in water. The cellulose fiber is preferably fibrillated to such an extent that the final specific surface area of the formed MFC is from about 1 to about 300 m.sup.2/g, such as from 1 to 200 m²/g or more preferably 50-200 m²/g when determined for a freeze-dried material with the BET method. These cellulose fibers and fibrils are typically manufacture from plant materials and are typically not considered textile materials, even though they may be specially treated or added into textile blends. Typical sources of the fibers and fibrils are wood, stalk (corn, wheat, grain, vine, etc.), bark, leaf, peel, husk, chaff and other residual plant materials.

These materials are well known in the art as exemplified by U.S. Pat. No. 4,374,702 (Turbak) which evidences a microfibrillated celluloses having properties distinguishable from all previously known celluloses. These are produced by passing a liquid suspension of cellulose through a small diameter orifice in which the suspension is subjected to a pressure drop of at least 3000 psig and a high velocity shearing action followed by a high velocity decelerating impact, and repeating the passage of said suspension through the orifice until the cellulose suspension becomes a substantially stable suspension. The process converts the cellulose into microfibrillated cellulose without substantial chemical change of the cellulose starting material.

Other examples of microfibrillated cellulose are shown in U.S. Pat. No. 4,481,076 (Herrick) evidencing how a redispersible microfibrillated cellulose is prepared by the addition to a liquid dispersion of the microfibrillated cellulose, an additive compound capable of substantially inhibiting hydrogen bonding between the cellulose fibrils. The microfibrillated cellulose, upon drying, is characterized by having a viscosity when redispersed in water of at least 50% of the viscosity of an equivalent concentration of the original dispersion.

U.S. Pat. No. 6,214,163 (Matsuda) evidences super microfibrillated cellulose having an arithmetic average fiber length of 0.05 to 0.1 mm, a water retention value of at least 350%, a rate of the number of fibers not longer than 0.25 mm of at least 95% based on the total number of the fibers as calculated by adding up, and an axial ratio of the fibers of at least 50. The super microfibrillated cellulose is produced by passing a slurry of a previously beaten pulp through a rubbing apparatus having two or more grinders which are arranged so that they can be rub together to microfibrillate the pulp to obtain microfibrillated cellulose and further super microfibrillate the obtained microfibrillated cellulose with a high-pressure homogenizer to obtain the super microfibrillated cellulose. A coated paper produced with a coating material containing the super microfibrillated cellulose, and a tinted paper produced from a paper stock containing the super microfibrillated cellulose as a carrier carrying a dye or pigment are also provided.

U.S. Pat. No. 5,964,983 (Dinand) evidences a microfibrillated cellulose containing at least around 80% of primary walls and loaded with carboxylic acids, and a method for preparing same, in particular from sugar beet pulp, wherein the pulp is hydrolysed at a moderate temperature of 60-100. degree. C.; at least one extraction of the cellulose material is performed using a base having a concentration of less than 9 wt. %; and the cellulose residue is homogenised by mixing, grinding or any high mechanical shear processing, wherein, after the cell suspension is fed through a small-diameter aperture, and the suspension is subjected to a pressure drop of at least 20 MPa and high-speed sheer action followed by a high-speed deceleration impact. The cellulose is remarkable in that a suspension thereof can easily be recreated after it has been dehydrated.

U.S. Pat. No. 8,642,833 (Waxman) evidences a reusable absorbent article includes a hydrophilic top layer, a soaking layer adjacent to and beneath the top layer, a substantially liquid impermeable layer adjacent to and beneath the soaking layer, and a backing layer adjacent to and beneath the substantially liquid impermeable layer. All of the layers are secured together to form a unitary structure. The soaking layer is a non-woven fabric having a plurality of hydrophobic fibers of a generally circular cross-sectional shape and a plurality of hydrophilic fibers of a non-circular cross-sectional shape. A second or intermediate absorbent layer is disposed adjacent to and beneath or below the top layer. In particular, a top surface of the second layer is directly in contact with a second or bottom surface of the top layer. The second layer is an absorbent layer that functions as a distribution or soaking layer, for absorption, containment and distribution of liquid. The soaking layer has a thickness of approximately 2.5-3.0 millimeters, and a mass per unit area of 350 grams per square meter. The soaking layer is preferably made of a non-woven needle punch fabric and comprises a plurality of hydrophobic fibers and a plurality of hydrophilic fibers. The hydrophobic fibers are preferably polyester fibers and have a generally circular cross-sectional shape. The hydrophilic fibers, on the other hand, are shaped fibers, meaning they have a non-circular cross-sectional shape, and are preferably made of a polyester resin. The hydrophilic shaped fibers have a denier of approximately 3.0 and, more preferably, of 2.78, a length of approximately 3-5 centimeters and a diameter of approximately 4-5 microns. Preferably, the soaking layer comprises approximately 60-65% polyester hydrophobic fibers and 35-40% hydrophilic fibers. The polymers described, such as polyester, also includes copolymers of those materials, and with polyesters, these are often referred to as copolyesters (coPolyesters).

Each document cited herein are incorporated by reference in its entirety.

One concept in the trial of various fiber blends was to manufacture wet-laid nonwoven media that 1) still provided good absorbency and retention properties and 2) could be coated with an antiviral/antibacterial solution.

The following materials were used to manufacture media handsheets:
1) Polyester/Co-polyester bicomponent fibers, 2 denier per fiber, 6-mm length
2) HP 11 Woodpulp fibers
3) Cotton linters pulp
4) Rayon fibers, 1.5 denier per fiber, 12-mm length
5) Polyester fibers, 0.5 denier per fiber, 6-mm length.

Fibers were weighed out in the percentages shown on the table, combined in a water solution, thoroughly mixed, and then the mixture was poured into a handsheet former. The target basis weight of the handsheet was 80 grams per square meter.

The antimicrobial used was a silver-based antimicrobial, Lurol® AG-1500 from Goulston Technologies, supplied as a liquid emulsion. The emulsion was diluted 50% with water before applying to the handsheet samples. The target loading for the Ag-1500 was 10% by weight.

Microfibrillated cellulose was supplied as a 2% fiber by weight in water mixture. To prepare handsheets with 2% microfibrillated cellulose add-on, the mixture was diluted to 0.02% by weight before spraying on the handsheet. To prepare handsheets with 5% microfibrillated cellulose add-on, the mixture was diluted to 0.05% by weight before spraying on the handsheet. In some handsheets, the Lurol® Ag-1500 was applied before the microfibrillated cellulose (“Before MFC”). In other handsheets the Lurol® Ag-1500 was applied after the microfibrillated cellulose (“After MFC”).

To measure absorbency and moisture retention, 1-in ×2-in samples of each handsheet were initially weighed and then immersed in water for 60 seconds and allowed to dry in air at room temperature and 70% RH for 60 seconds. After 60 seconds of drying, the samples were weighed to determine the amount of water they absorbed; this amount was recorded as the absorbency. Samples were allowed to continue drying and were weighed over time to determine the amount of water they retained. Three samples from each handsheet were used for the tests.

Fractional efficiency testing was performed on selected handsheets by LMS Technologies of Bloomington, Minn. The testing used neutralized sodium chloride particles with particles diameters ranging from 0.3-10 micron. Testing was performed at 71° F. and 50% RH at an air flow rate of 10 ft/min. The testing used 10-in ×10-in handsheet samples.

### Results of Manufacture and Measurements

### Absorbency and Retention:

This desirable set of properties was met with several blends. Absorbency and moisture retention results showed that the fiber blend materials made at the trial had similar performance to the absorbency and moisture retention properties of the superabsorbent fiber air-laid materials made according to the Gray Patent cited above several years ago.

The results show that absorbency is not only affected by the type of fiber used in the media, but also by the fiber structure in the filter media.

The attached tables show the results for absorbency and moisture retention. Charts provided show the absorbency and retention properties for the different fiber blends. The charts also show the effect of adding microfibrillated cellulose to the fiber blend during the manufacturing process. Surprisingly, the microfibrillated cellulose did not increase absorbency or moisture retention for the fiber blends although it did significantly increase filtration efficiency, as well as tensile and stiffness properties of all the samples.

Another advantage of the new blends is that any added antimicrobial coating (gel, liquid or aqueous-activated solid) or antiviral coating was able to be applied during the media manufacturing process. Manufacturing costs for the coated media can be reduced significantly if the coating can be applied during the media manufacturing process rather than in a separate manufacturing process step.

All the blends manufactured in the trial were able to be coated or imbibed with the antiviral coating. The media blends made during the trial are also more wettable than the previous superabsorbent fiber media, so they can absorb any liquid faster and keep any liquid droplets from remaining on the surface for any length of time.

The addition of the microfibrillated cellulose (MFC) did not seem to negatively affect the process for coating the media with the antimicrobial/antiviral coating. Samples were made where the antiviral coating was applied before the MFC was added, and samples were made where the antiviral coating was applied after the MFC was added. The air permeability and efficiency of both types of samples were similar. These results indicate that the coating did not film over the small MFC fibers nor did the coating process remove a significant amount of MFC fibers. However, these samples were made using only one antiviral solution; different solutions may show different results.

### SECONDARY CONSIDERATIONS

The blended fabric material has advantages in the personal protection (facemask) as well as industrial filtration applications. The superabsorbent fiber nonwovens in previous application had low filtration efficiencies and were relatively thick. In addition, several media manufacturing processes, particularly lower-coat wet-laid processes, are not able to run with superabsorbent fiber, and the superabsorbent fiber itself is relatively expensive and large compared to many other fibers that can be used in PPE and filtration media. Essentially, a functionally desirable replacement for superabsorbent fiber media was found that provides more options to supply competitive media for a variety of applications. Although the degree of water-absorbency does not exceed the water-absorbency of media with a high percentage of superabsorbent fiber, other more critical properties such as particle filtration efficiency were exceeded.

### Results

Media blends made during the trial can be manufactured using a wet-laid process, which will make them less expensive to produce in large volumes. In addition, the media blends made during the trial also have the following advantages:

Higher filtration efficiency—particularly for blends using 1.5% to 8% by total weight of fibers (excluding moisture content) or from 2% and 5% by such total weight of fibers in the fabric of microfibrillated cellulose. Filtration efficiency can be increased further with additional small fibers with diameters less than 2-microns. Or, the current media blends can be used as a base and a thin layer of meltblown fiber could be applied or laminated to it. The spreadsheet on fractional efficiency includes the prior results on the Gray Patent superabsorbent fiber media tested in October 2013. As can be seen, the new blends provide higher filtration efficiency across the range of particle sizes tested.

These properties are evidenced in the attached tables provided as Figures.

In addition, compared to the prior superabsorbent fiber media, the media blends tested were able to achieve higher filtration efficiencies with significantly lower pressure drop. This result means that a facemask or other product can be manufactured with the new blends which will provide better breathability and better efficiency. Because the materials are thin and the pressure drop across them is low, if higher efficiency is desired, additional layers of the material can be used while the overall product can still retain good breathability.

Quality Factor is a comparison used to rank filter media based on their relative efficiency and pressure drop; it is an attempt to recognize that higher efficiency at a low-pressure drop is more desirable than high efficiency at a high pressure drop. As seen in the efficiency spreadsheet, the quality factors for the new blends of media are significantly higher than the quality factors for the previous superabsorbent media, in some cases an order of magnitude higher.
1) Media blends can likely be pleated and corrugated, which can be necessary for some filtration applications. Pleating a media allows one to pack more filter media into a filter, which will increase the amount of surface area available for filtration and increase the efficiency and overall holding-capacity of the filter product. Even with an additional layer of fine fiber media (such as meltblown, electrospun, microcellulose, or other fibers with diameters less than 2.0 micron) added for high efficiency, the media will still be able to be pleated. Corrugations increase stiffness and provide self-spacing for tightly pleated media, which allows for use in many filter applications.
2) Ultrasonic and thermal bonding capability. The media blends can be ultrasonically bonded or thermally bonded—particularly the A and C blends with >50% synthetic fiber. These types of bonding methods provide an advantage in both cost and performance over filter media that need an adhesive resin in order to bond. Because the media will not require an adhesive bond, they can be laminated with less cost and also have more open pores available for storing contaminants and allowing for higher air flow; adhesive resin will plug pores to some extent.

### Surprising Results

1) In combination with the microfibrillated Cellulose (NFC) fibers, absorbency and moisture retention were often higher in the blends that had >50% (up to 80%) by total weight of textile hydrophobic fibers (A and C blends) than they were in blends that had >50% hydrophilic fibers (up to 70% by textile fiber weight, as in the B and F blends). This result was consistent across all levels of MFC loading as well.
2) The addition of microfibrillated cellulose actually decreased the absorbency and did not increase the moisture retention of the material. Microfibrillated cellulose is often used to increase moisture retention in several applications; it also has an initial absorbency of >10 g water/g in most literature reviewed. The particular fiber media structure may have impacted the effect of the microfibrillated cellulose; the antiviral coating may have played a role as well. However, the blends with MFC still have sufficient absorbency and moisture retention for many medical applications and also provide large benefits in efficiency, tensile strength, and stiffness.

It is also been found that stiffness and tensile strength can increase from the MFC addition, and that property will be significant. In forming (molding, corrugating, bending, cutting and fitting), the increase in tensile strength increases useful life of the materials often caused by these structural processes performed on the media.

What is claimed:

1. A gas filtering medium comprising hydrophobic polyester fiber as from 20-80% by total weight of textile fibers and 80-20% by total weight of hydrophilic textile fibers and a microfibrillated cellulose fiber in a weight/weight ratio of 1.5-8.5/100 parts by weight of total textile fiber.

2. The gas filtering medium of claim 1 wherein the medium comprises a non-woven fabric.

3. The gas filtering medium of claim 2 wherein the non-woven fabric is a wet-lain non-woven fabric.

4. The gas filtering medium of claim 2 wherein the hydrophilic fiber comprises a natural fiber.

5. The gas filtering medium of claim 2 wherein the hydrophilic fiber comprises a synthetic fiber.

6. The gas filtering medium of claim 1 wherein the microfibrillated cellulose comprises a cellulose particle fiber or fibril with at least one dimension less than 500 nm.

7. The gas filtering medium of claim 3 wherein the microfibrillated cellulose comprises a cellulose particle fiber or fibril with at least one dimension less than 500 nm.

8. The gas filtering medium of claim 4 wherein the microfibrillated cellulose comprises a cellulose particle fiber or fibril with at least one dimension less than 500 nm.

9. The gas filtering medium of claim 5 wherein the microfibrillated cellulose comprises a cellulose particle fiber or fibril with at least one dimension less than 500 nm.

10. The gas filtering medium of claim 1 having a particle filtration efficiency of greater than 50% for 7 micron particles with a flow rate of particle-bearing gas at flow speeds of 10 feet/minute.

11. The gas filtering medium of claim 3 having a particle filtration efficiency of greater than 50% for 7 micron particles with a flow rate of particle-bearing gas at flow speeds of 10 feet/minute.

12. The gas filtering medium of claim 5 having a particle filtration efficiency of greater than 50% for 7 micron particles with a flow rate of particle-bearing gas at flow speeds of 10 feet/minute.

13. The gas filtering medium of claim 7 having a particle filtration efficiency of greater than 50% for 7 micron particles with a flow rate of particle-bearing gas at flow speeds of 10 feet/minute.

14. The gas filtering medium of claim 8 having a particle filtration efficiency of greater than 50% for 7 micron particles with a flow rate of particle-bearing gas at flow speeds of 10 feet/minute.

15. The gas filtering medium of claim 9 having a particle filtration efficiency of greater than 50% for 7 micron particles with a flow rate of particle-bearing gas at flow speeds of 10 feet/minute.
